(19) United States
(12) Patent Application Publication
(10) Pub. No.: US 2009/0037408 A1
(43) Pub. Date: Feb. 5, 2009

(54) Essence based search engine

(76) Inventor: James Neil Rodgers, Langley (CA)

Correspondence Address: JAMES NEIL RODGERS, 8853 214TH PLACE, LANGLEY -- BRITISH COLUMBIA, V1M 2H9, CA

(21) Appl. No.: 11/833,988

(22) Filed: Aug. 4, 2007

(51) Int. Cl. G06F 17/30

(52) U.S. Cl. 707/5; 707/E17.108

(57) ABSTRACT

The useful, non-obvious and novel step of this invention is to present a design and methodology for a search engine tool which properly identifies and categorizes the elements to be searched through the initial step of human parsing. This invention is called essence based searching. Essence based searching is an advancement in the art as current search methodologies are almost exclusively sub-categories of word searches. Specifically, and in the context of patent searches, the present invention identifies the inventive steps, those elements which are useful, non-obvious and novel, of any particular patent and connects these inventive steps as identifier tags to an index of patents. Each identifier tag is less than 72 characters in length. These inventive step identifier tag lines when connected to an index change the nature of the currently used patent invention search engines from key word based to a concept (essence) based search paradigm. The heart of this invention is the human parsing of inventive step identifier tags by persons ordinarily skilled in the art. The search results are displayed chronologically and numerically and then point, through a five step index, to follow on sections known as embodiments, executive summary, claim limitations and decision tree. This essence based search paradigm as a tool for searching electronic textual documents is applicable to any electronic database using text as a medium.

### BACKGROUND OF THE INVENTION

Prior art teaches that searches of an electronic database should be by way of keyword query. The challenge with prior art word based searching techniques is that they are ineffective. In order to find the item being sought the search query paradigm requires input on the exact words found in the document. If, for example, an inquisitor has searched for the key word term “RFID transponder” and a highly relevant document in the database stated, “transceiver for the purposes of RFID” or “RFID tag” or “RFID passive transponder” the search results will not produce the second, third or fourth documents if the search engine is utilizing conventional keyword search tools. The present invention teaches that sorting data by essence, and not by keyword input, simplifies, quickens and sharpens the search engine process. Essence searching results in quicker and more precise responses as contrasted to key word input query. Using the example of a patent database the present invention contemplates indexing data by useful, non-obvious and novel steps, called “Inventive Steps” herein, which is conducive to precise and quick searching of patent data through the use of, for example, indexed identifier tags.

One of the reasons for a proposed departure to essence based indexing for electronic databases is that keyword searches have a difficult chore in distinguishing between words that are spelled identically yet have separate meanings. These are known as homonyms. For example, consider a hard stone, a hard exam or the hard drive on your computer. The word “hard” occurs in three areas as a descriptor yet has a separate meaning in each case. This different meaning phenomenon can cause confusion to a key word based electronic search engine which results in many irrelevant responses to genuine queries. Furthermore, key word searches can produce stemming problems. Stemming means that if a key word query is entered into an electronic search engine for the word “large”, then a keyword search database struggles with whether it should send a response for the word “larger”, “largest” etc. There is the identical stemming problem in keyword based searching for plural and singular words as well as with verb tenses where the difference in the query word is by an “S” or an “ed”.

Another deficiency with a keyword based electronic search engine is that it cannot return answers on keywords that mean the same thing but are not actually entered in the initial search query. These are known as synonyms. For example, a database query submitted as “heart disease” would not return answers on “cardiac arrest” or on “heart attack”. In this example many bona fide results would not be returned by the electronic key word driven database resulting in a skewed search.

Within the keyword based search genre, which is designed for a typical key word powered electronic search engines; two different types of searches are usually offered. There is the basic search and the advanced search. The basic search is a keyword entry system which does not include a feature for sifting through pull down menus of options to refine the search parameters. Notwithstanding the refined search capability of an advanced search, including pull down menus, if the search engine has enough horsepower then the basic search can become quite complex. If the refined search option is chosen then some of the possibilities include the ability to search on more than one word, to give more weight to one search term than given to another, and to exclude words that might be likely to muddy the results. There may also be the ability to search on proper names, on phrases, and on words that are found within a certain proximity to other search terms. Furthermore, some electronic search engines allow the inquisitor to specify the form in which the results are to appear such as chronological, alphabetical etc. The search can also be restricted to certain fields. For example, in the case of the “quick search” feature at the United States Patent and Trademark Office (hereinafter “USPTO”) the fields of search are fulsome and include thirty pull down menu categories including Abstract, Issue Date, Patent Number, Application Date, Application Type, Primary Examiner, Attorney or Agent, PCT Information, Related US Application Data and an All Fields category. These are in Field One. There is then a Field Two category where a key word can be input in contrast to Field One and this key word search is likewise limited to the same thirty fields of search. The results are presented as a list of reverse chronologically listed titles of patents which fit the key word based search parameters. The deficiency with this system, besides the key word problems noted above, is that the results are listed by title of the invention. The title is provided by the inventor. The title may or may not be relevant to the useful, non-obvious and novel steps which are the subject of the patent and its limitations. Therefore, the inquisitor must then take the patent number and pull up the complete patent filing including Abstract, Claims and Specifications. These must be read in total in order to accurately determine the useful, non-obvious and novel steps of the invention in question. In contrast, the present invention displays Inventive Steps instead of Patent Titles. In other words, the steps of reading the Abstract, Claims and Specifications have already been completed by the inventor of this system. The Abstract, Claims and Specifications have been mentally parsed and presented as a one line identifying tag. This useful, non-obvious and novel step points, via one line identifier, to an index which reveals the true substance or essence of the Patent instead of its inventor generated Title. Furthermore, the present invention displays the Inventive Steps identifying tags in chronological order as opposed to reverse chronological order as found at USPTO on line quick search facility. The present invention format results in a more logical search display in that one invention should follow on from another invention in the same category.

The USPTO goes on in the advanced search paradigm to offer Boolean operators. These are tools to build a query in order to present a more refined search in an electronic search engine. This advanced search format is presented on line at the website of USPTO. Building a more complex query requires the use of these Boolean operators. Boolean logic was originally developed by English mathematician George Boole in the mid 1 800s. The Boolean operators most often seen at electronic search databases are “AND” which means that all terms joined by this operator must appear in the pages or documents being searched. Some search engines substitute the + sign instead of using the word “AND”. Another Boolean operator is “OR” whereby at least one of the terms joined by “OR” must appear in the pages or documents being searched. Another operator is “NOT” which means that the terms following this word must not appear in the pages or documents. Some search engines substitute the operator “−” for the word. There is the operator “FOLLOWED BY” where one of the terms must be directly followed by the other. Furthermore there is the Boolean term “NEAR” which means that terms must be within a specified proximity or number of words of the first search keyword. The use of quotation marks tells the search engine that the words between the marks must be treated as a phrase and that this specific phrase must be found within the document or file. The searches defined by Boolean operators are literal key word searches. In other words the search engine looks for words or phrases exactly as they are entered. This can be problematic if the entered key words have multiple meanings. This is the same homonym problem aforementioned. As an example, a “bed” can be place to sleep, a place where flowers are planted, the storage space of a truck or a place where fish lay their eggs. If the search query is interested in only one of these meanings then pages of search returns featuring the other meanings is irrelevant. The sophistication of Boolean operators does not disguise the basic deficiency which is a complete reliance on key words to generate results for a search query.

The present invention teaches that concept, or essence based, searching, as opposed to key word searching, can be accomplished through use of identifying tags which are linked to a one line 72 character or less index which succinctly describes the inventive steps extant in any particular patent. This system improves upon the current state of the electronic data base searching art by teaching that an index of concepts will result in no homonymic or synonymic confusion as are prevalent when literal key word searches are utilized.

The present invention demonstrates that Boolean operators are black and white. However, most search results which are truly beneficial to an inquisitor are in the gray zone. That is to say that they are neither black nor white, on or off, here or there or any of the other logically exclusive categories normally used to designate search parameters. This invention teaches that searching the gray area efficiently and effectively requires mental parsing by a human being(s). Mental parsing is accomplished by reducing an electronic search database to an identifier tag index connected to one line inventive step descriptors. Gray zone search results cannot be effectively accomplished through the use of logical definers. The use of logical definers invalidly attempts to utilize a mechanical device to find a creative concept or “something” which is non-mechanical. That “something” is the creative genius which gives life and breath to a patented invention. Creative genius and logical categories are, by definition, mutually exclusive. In other words, if a creator thinks outside of the box then the boxlike logical search techniques will not disclose the invention. As another example think of using already defined cookie cutters to find a novel or new cookie design. This system will not work, except by trial and error. History has taught that trial and error is a woefully inefficient and tremendously expensive searching methodology.

Mentally parsed identifier tags allow the owner of a patent or Patent Examiners to specify key concepts under which the patented invention will be indexed. This can be helpful especially in cases in which the words on the page might have double or triple meanings as eluded to above. The identifier tags can guide an electronic search engine in choosing which of the several possible meanings for these words is correct by reducing the index to concept based searching paradigms, known herein as essence based searching. Electronic database search engines use automated software programs known as spiders or bots to survey the potential targets for a search inquiry. The programs retrieve information and then store them by way of an index comprised of key words. When a search is entered by an inquisitor it is checked against the search engine index. The text query and retrieval is accomplished by the use of key words. A key word is simply any word on a textual document, such as a patent document. For example the word “simply” was used in the previous sentence which makes it one of the key words for this textual document. That key word will eventually become part of the USPTO key word search archives. The problem is that the word “simply” has nothing to do with the concept of electronic data base searching except in the most peripheral or banal of meanings. On the other hand, useful key words to search for this textual document would be “electronic search engines” or “database inquiries” and the like. The point is that these key words are really word descriptors of concepts. The present invention advocates concept (essence) based electronic data base search paradigms as contrasted to a key word based search paradigms. Unless the author of this document designates the key words “electronic search engines” or “database inquiries” or the like as part of the identifier tag search paradigm for this document then it is up to the search engine to determine these concept descriptors. In essence the search engine pulls out and indexes words that appear to be significant. As the software for search engines are not rational human beings they are designed to operate according to algorithmic protocols determined by their creators. This means that words contained in the title to a document are given inordinate importance. To restate the obvious, the problem is that if the title of a patent document does not describe the useful, non-obvious and novel steps of a patent, the key word search will not be relevant to the concept which is being sought. Moreover, key words that appear near the beginning of a document or in the abstract of a patent are given more weight by the USPTO search algorithm protocol. The same problem arises. For example, what if the Abstract and first paragraphs of the Specifications concentrate on describing prior art and the specifics of what the prior art teaches. The word based search algorithm will not then pick up the useful, non-obvious and novel step which is being taught by the patent in question but will pick up the useful, non-obvious and novel steps of the prior art.

Furthermore, key word based search engines default towards words that are mentioned the most times in a document. The deficiency of this type of search paradigm is obvious in the case of patent documents. For example, what if the inventor spends most of the time in a patent document describing prior art. The word based search algorithm will not pick this up and a spurious result will be displayed to the inquisitor.

Once the spiders or bots have completed the task of locating germane information on textual document pages the search engine needs to store the information in a way that makes it useful. There are two components which make the mined data accessible to users: First, the information stored with the data and, second, the method by which the information is indexed. In the simplest context, a search engine could store the word being searched and its location, via URL or some other method of identification. In this scenario it would not be possible to rank the list of hits because it is not known whether the key word was used once or many times or whether the page contained links to other pages containing the word.

To make the search results more useful most search engines store information about the number of times the keyword is used in the document. A weight may be assigned to any key word by identifying with increasing values assigned to words as they appear near the top of the document, in sub-headings, in links, in the meta tags or in the title of the page. Each commercial search engine has a different formula for assigning weight to the words in its index. This is one of the reasons that a search for the same word on different search engines will produce different lists, with the pages presented in different orders. This is due to an algorithmic procedure known as relevancy ranking. In other words, the electronic search engine with a key word based protocol will list inquisitor hits according to how closely they think the results match the query. However, these lists often leave inquisitors in confusion as the results are often irrelevant. As stated, the frequency and positioning of key words are relevancy ranking tools used by key word based electronic data base search algorithm protocols. For example, if the term “RFID” appears a multiple of times in a patent document a word based search algorithm will rank this document as an inquisitor's hit. However, if the document is actually contrasting RFID with a competing technology such as bar code and in reality adds nothing to the art of RFID per se, then this hit is irrelevant to RFID technology and adds only to the confusion of the inquisitor. In terms of a Patent Examiner it adds frustration and stress. More frustration and more stress are not needed in the professional life of a Patent Examiner. This is a profession based on production protocols. If the search tools available to any particular Patent Examiner are key word based search protocols the inquisitor hits can result in nothing but slowed production due to the numerous deficiencies enunciated above.

Regardless of the precise combination of additional pieces of information stored by an electronic database search engine, the next process is that the data will be encoded to save storage space. As an example the original Google paper describes using two bytes, or 8 bits each, to store information on weighting of items to be searched. The stored information includes data on if the word was capitalized, its font size, position, and other information to assist in ranking the hit, also known as the response. Each factor might take up two or three bits within the two byte grouping. As a result, a great deal of information can be stored in a very compact form. After the information is compacted, it is ready for indexing.

An index has a single purpose; it allows information to be found as quickly as possible. There are quite a few ways for an index to be built. One of the most effective ways is to build a hash table. In hashing, a formula is applied to attach a numerical value to each word. The formula is designed to evenly distribute the entries across a predetermined number of divisions. This numerical distribution is different from the distribution of words across the alphabet, and that is the key to a hash table's effectiveness.

For example, in English, there are some letters that begin many words while others begin fewer. A quick flip through the English language dictionary demonstrates “M” starts many more words than “X” does. This inequality means that locating a key word which starts with a popular letter could take much longer than finding a word that begins with a less popular one. Hashing evens out the difference and reduces the average time it takes to find an entry. It also separates the index from the actual entry. The hash table contains the hashed number along with a pointer to the actual data, which can be sorted in whichever way allows it to be stored most efficiently. The combination of efficient indexing plus effective storage, as in the Google example above, makes it possible to get results quickly, even when the user creates a complicated search. The present invention takes hashing a step further by reducing the raw data into conceptually based core identities known as essences. In the embodiment of a patent search engine this results in data being categorized as useful, non-obvious and novel steps which are referred to as “Inventive Steps”. Therefore, instead of simply hashing key letters of the alphabet the present invention hashes the data into exact concept categories and concepts known as essences. The result is an enormous increase in search efficiency, speed and exactitude as the hash is the identifier tag which points directly to the index.

In terms of USPTO electronic databases, the main factor which has prevented this critical federal office from becoming a pure patent registration system is that the Patent Examiners are adept at using issued patents as limitations to the scope of patent applications. These same overworked Patent Examiners use some non patent prior art to also act as limitations for patent applications. In this way the USPTO Patent Examiners can determine if claim limitations overlap; but only to the extent that an East/West patent search will provide adequate results through the auspices of a key word based search protocol.

The East/West system has some problems in that Titles cannot be sorted and reviewed individually by Examiners. After a list of Titles is presented to an Examiner then each Title must be displayed in context or by using the Abstract.

The East/West system cost USPTO $40,000,000 to put into place in October of 1999.

The goal of both the Web based Examiner Search Tool (WEST), and the Examiner Automated Search Tool (EAST) is to integrate computerized word and image searches to speed the process for a quality Patent Examiner search. However, the search process with WEST is anything but speedy, and EAST, while faster, sacrifices search quality for increased velocity.

Both EAST and WEST use the same data files and rely on the same BRS text search algorithms. BRS is a licensed piece of software which in itself has some deficiencies. It is stated by former Patent Examiners that BRS has at its core hopelessly corrupted logic and poor indexing. For example, when BRS was instituted on EAST and WEST it allowed only 600 simultaneous search requests. This is in contrast to numerous USPTO accepted Patents which teach software art which clearly establishes tens of thousands of simultaneous search requests. BRS, when first instituted, and which feeds both EAST and WEST, ran 17 to 1,000 times slower than Messenger, the system which it replaced. EAST and WEST use the same data files and rely on the same BRS text search algorithms and indexing methodology. Text search result differences between EAST and WEST are functions of user customizations of the interfaces. For example, the OR operator is the system default for both EAST and WEST, although, when instituted, WEST supported changing the default operator at the user's choice.

The EAST and WEST system, (hereinafter “E/W”) as an information management tool, and when first implemented at USPTO, changed the prevailing Boolean operators. For example, the new truncation symbols such as (?) have caused errors by returning incomplete search results as opposed to the (!) symbol used in Messenger. The (?) character in BRS designates one character which must be present and does not designate unlimited truncation as with Messenger. When implemented it was necessary for Patent Examiners to set default settings of E/W the same to ensure equivalent results. Furthermore Patent Examiners needed to use limited rather than unlimited truncation. They also needed to avoid use of simultaneous left and right truncation as it used too much of the limited E/W system resources and took an inordinate amount of time to complete. Patent Examiners also needed to search less commonly occurring terms first as common terms are highly posted and take more time to process. Furthermore, Patent Examiners needed to use an L-number for each concept per search and then to combine L-numbers. Moreover, Patent Examiners needed to distribute operators to accelerate search rates.

Additionally, Patent Examiners were encouraged to use automatic plural settings judiciously. It was stated that plurals should only be used as specifically mentioned in the technology in question. However, plurals, as defined by BRS, included American-British term equivalents and abbreviations-full spellings equivalents. So, for example, if a Patent Examiner set Plurals Off, then “tire” would not retrieve “tyre” and “prepn” would not retrieve preparation. In using the “!” symbol the plural/equivalents function can be turned off which then forces BRS to search only the term as specified.

Patent Examiners were encouraged not to use relevance ranking features for large answer sets of 5,000 or more hits. This was because efficient text searching should only be used in the final refinement stages of searching as the relevance features uses too much of E/W system resources.

The default operator in EAST is OR. Therefore to search a phrase such as “RFID tags” the term RFID adj tags should be used.

These examples are some of many E/W intricacies which hampered Patent Examiners in their use of E/W as it first came into use at USPTO.

The present invention takes information management beyond the parameter of a simple keyword search which is at the heart of BRS and E/W. It proposes that all data be reduced to their essence. This essence, also known as “Inventive Steps” in the Patent Search embodiment portion of the present invention, is produced as an identifier tag on the search engine index. Therefore, the problems and deficiencies aforementioned which abound in a key word based search protocol are avoided. However, the essence of any concept cannot be determined by a machine. These concepts must, at this stage of technological sophistication, be mentally parsed. Using key word algorithms in any form leads only to erroneous and irrelevant search results.

### PRIOR ART

Concept (essence) based searching identifies and suggests alternative search queries that are closely related to the inquisitor's initial search parameters. As such, defining the present invention as a concept based electronic data base search tool, is inaccurate. The present invention teaches that refining the data, not the search technique, so that it fits with predetermined concepts, will ensure accuracy of search results for inquisitors. However, as prior art, and in general, the concept based field of search engines must be canvassed.

Microsoft Patent Application 20060248068 dated Nov. 2, 2006 analyzes the density of a given query at various points in time. This means that it ranks the number of searches for a particular word compared to the overall number of searches to determine a semantic correlation. A mathematical process called Fourier analysis is used to make rapid comparisons between various results. For example the change in popularity for searches regarding the “Winter Olympics” may correlate positively with “ice hockey” or “curling”. This information is fed back to inquisitors for review and search refinement. The distinction between the Microsoft Application and the present invention is that the Microsoft Application proposes a variation on a key word search by suggesting alternative key words to the inquisitor. The present invention, in stark contrast, proposes that the data itself be refined to specific categories so that inquisitor searches are directed to the essential concept of the item being searched instead of to key word descriptors. The result is inquisitor searches are more accurate and efficient on concepts which have been mentally parsed and indexed by the use of objectively determined meta tags.

U.S. Pat. No. 6,675,159 titled, “Concept-based search and retrieval system” authored by Lin et. al. describes a concept based indexing system though collections of documents with ontological based predicate structures. This invention uses both automated and human assisted methods. This invention extracts the concepts which buttress an inquisitor's search and the retrieval system comprehends the intent behind the query. This system purports to return results which match the intent of the inquisitor. The present invention can be distinguished from U.S. Pat. No. 6,675,159 in that predicate structures are not arranged in an ontology using automated means. The present invention categorizes the essence of items in a data base through the process of human parsing. In other words, the data is read by a human being and reduced to a one line meta tag which describes the essence of the data. This meta tag is then indexed and can be searched through normal word methods.

### SUMMARY OF THE INVENTION

The deficiencies described above and taught in the prior art are addressed by the present invention which teaches an essence based identifier tag indexing and search system plus a methodology for same. The system advocates the extraction of the essence of data entries exclusively through the use of human parsing. The essence based identifier tag indexing and search system of the present invention improves precision, speed and accuracy of data retrieval. The present invention does not require the knowledge of answers prior to query but categorizes data into their essence and assigns an identifier tag to each prior to indexing. In this regard this invention is a useful, non-obvious and novel step over and above the prior art.

### DETAILED DESCRIPTION OF THE INVENTION

In the first embodiment of the present invention a search engine for the USPTO classification of RFID is described. All Abstracts, Claims and Specification sections of any and all USPTO Patents and Patent Pending published applications in the classification RFID must be read by a human being(s) who is (are) ordinarily skilled in the art of RFID technology.

The first task is to cull out those documents which may refer to RFID tangentially, marginally or as a contrasting item but wherein no useful, non-obvious and novel step in the field of RFID is taught. In this case roughly one-third of the RFID hits were dismissed.

The second task is to create a one line identifier tag for each Patent or Pending Publication wherein it has been determined by the human parser that a useful, non-obvious and novel step has transpired. These are referred to as Inventive Steps. Each Inventive Step is given an identifier tag such as R/Antenna/Dipole/Copper/Insulation. This identifier tag tells an inquisitor, such as a Patent Examiner, that in the classification of R (RFID technology) an Inventive Step has transpired involving a dipole antenna constructed of insulated copper. If this identifier tag line when displayed as a search result is of interest to the Patent Examiner a second one line descriptor can be accessed through the connection between the identification tag and the index which describes the Embodiments of the original Inventive Steps. For example, E/Antenna/Wireless cash recorder/Portal Structure/Shopping malls. This one line Embodiment descriptor tells an inquisitor, such as a Patent Examiner, that in the Embodiments and Detailed Description section of the Specifications section of the Patent or Publication that the embodiments of the invention specifically mention an antenna design for a wireless loop portal cash recorder to be used in shopping malls.

The third task is to provide an Executive Summary of the Abstract, Claims and Specification of each Patent and Published Application so that an interested party, such as a Patent Examiner, can quickly read in five lines or less the essence of the invention. For example, using the above context, “This invention proposes the use of a novel RFID antenna based on a dipole structure. The antenna is constructed of copper but is specially insulated using proprietary techniques, specifically polymer coatings, to reduce interference. It is designed to operate in a portal structure connected to a back end cash management system. It can operate with contact less smart cards.”

The fourth task is to outline the limitations of the claims of the Patent or Pending Publication. In the context of the above example the limitations would be as follows:

1.) L/RFID/Antenna/Dipole;

2.) L/Copper/Insulated/Polymer resins;

3.) L/Portal/Contact less smart card.

This simple example would indicate to an inquisitor of interest, such as a Patent Examiner, that the metes and bounds of the claims of this particular patent are an invention in the classification of RFID involving a dipole antenna design using copper base materials while employing polymer resins as insulation for the purpose of creating a shopping mall portal for customer cash collection using contact less smart cards.

The fifth task, using the current example, is to categorize all RFID Antennas using a Dipole design into one easily accessible category. The data base lays each Patent or Patent Pending publication item in this category side by side to form a jig saw puzzle of claims limitations. In the circumstance where two Patents or Pending Publications have overlapping limitations the data base alerts the inquisitor, such as a Patent Examiner, that an invalid patent decision has been taken or is about to be taken. This procedure removes all subjectivity from a decision equation for a Patent Examiner in that overlapping limitations are obvious and not influenced by subjective interpretation. This then alleviates stress on the Patent Examiner and increases productivity. On the other hand, a valid patent decision alerts the Patent Examiner that limitations for any particular Patent or Pending Publication or Application are contiguous to or do not overlap existing or proposed claims and are therefore valid claims. Furthermore, the design paradigm of the present invention can alert an interested Inquisitor, such as an Inventor, to areas in the RFID Dipole Antenna category where a Valid decision on a Patent has been rendered however, the claims limitations are not contiguous. In other words there is a space or vacuum which exists between two (or more) groupings of claims. This space or vacuum will indicate to a person ordinarily skilled in the art, who possesses a talent for creativity, an opportunity to develop a patentable concept if it is deemed a useful, non-obvious and novel step. This last section of this present Invention is called the Decision Tree portion. As an example, using the context above, the Decision Tree will state that there is no invention in this precise category which uses contact smart cards for the same process. If it is deemed of commercial value, an inventor or corporation could then file an a patent application using the useful, non-obvious and novel concept of a contact smart card as opposed to a contact less smart card for a shopping mall cash portal with dipole antenna design made of copper and insulated by polymer resins.

Other preferred embodiments of the present invention include every, and all, textual electronic data base search engines. The essence based paradigm outlined herein is limited only by the number of human parsers available in any field of endeavor who can physically read a textual document and reduce it to a one line identifier tag. All further refinements in follow on embodiments are then specifically engineered to fit the need of the data base and its users in any given situation. However, once human parsing is accomplished the efficacy, accuracy, speed and utility of the methodology and system of the search engine tool presented herein far exceeds that which is taught in the prior art.

1. A method for constructing an essence based electronic database searching tool for textual documents comprising the first step of data parsing by human beings of said textual documents so that the essence of the data is reduced to a single line identifier tag of no more than 72 characters which forms an essence structure which comprises an identifier tag index system which is electronically connected to an Embodiment, Executive Summary, Limitation and Decision Tree section whereby the Embodiment section of the database describes in 72 characters or less the potential uses of the essence, the Executive Summary describes in 350 characters or less the general nature of the essence, the Limitation section describes in one line portions of 72 characters or less the metes and bounds of the essence and the Decision Tree portion describes in narrative form and by way of diagram the validity or invalidity of the essence as compared to similar data; wherein “essence” is defined as the underlying concept or absolute meaning of the data as understood by a person ordinarily skilled in the art and “validity/invalidity” is defined as true/false as understood by a person ordinarily skilled in the art.

2. A method of performing an essence based search of textual documents comprising the steps of electronically inputting a concept based query using everyday language which describes the colloquial essence of a concept which is directed to an index of identifier tag lines known as Inventive Steps which have been categorized in a manner which would be familiar to a person ordinarily skilled in the art so that the content of the electronic textual database is readily available to a query made in the jargon of the art in question and is made readily available to the inquisitor and will produce a response comprised of Inventive Steps in the first instance, Embodiments in the second instance, Executive Summary in the third instance, Limitations in the fourth instance and Decision Tree in the last instance.

3. A method of displaying the Inventive Steps in chronological order by not referring to Titles or Keywords in the textual documents in question but by referring to the essence of the textual document in question as developed by the human parser(s) who are ordinarily skilled in the art of the document in question and which essence, known as Inventive Steps, are applied as an identifier 72 character or less tag index to the follow on sections of Embodiment, Executive Summary, Limitation and Decision Tree and which identifier tag index is electronically connected thereto.

4. The system whereby the five sections of Inventive Step, Embodiment, Executive Summary, Limitation and Decision Tree can be displayed individually or as a collective or as a hybrid in the form of an electronic output to the electronic query of the inquisitor.

5. The system and methodology whereby claims 1, 2, 3 and 4 can be applied to any electronic textual database, including, but not limited to, the United States Patent and Trademark Office search facilities or any other electronic textual database whether accessed via the World Wide Web, internet, intranet, or library based onsite electronic database.
